(19) United States
(12) Patent Application Publication
(10) Pub. No.: US 2023/0408630 A1
(43) Pub. Date: Dec. 21, 2023

(54) POLARIZER ASSISTED STAR ISOLATION METHOD

(71) Applicant: BAE Systems Information and Electronic Systems Integration, Inc., Nashua, NH (US)

(72) Inventors: Alexander D. Johnson, Waltham, MA (US); Jonothan S. Jensen, Nashua, NH (US)

(73) Assignee: BAE Systems Information and Electronic Systems Integration Inc., Nashua, NH (US)

(21) Appl. No.: 17/841,860

(22) Filed: Jun. 16, 2022

(51) Int. Cl. G01S 7/02; G01S 7/03

(52) U.S. Cl. CPC G01S 7/0231; G01S 7/038

(57) ABSTRACT

A Simultaneous Transmit and Receive (STaR) system utilizing high power transmitters and high sensitivity receivers in conjunction with one or more signal polarizers to maintain far-field polarization efficiency for both transmission and reception of same (or similar) frequency content at the same time. This STaR system maintains far-field polarization efficiency to remote target(s) while simultaneously introducing a near-field polarization mismatch between the transmission and receiver subsystems for higher isolation and reduced coupling.

### TECHNICAL FIELD

The present disclosure relates generally to radio frequency (RF) transmissions and wireless systems. More particularly, in one example, the present disclosure relates to RF systems utilizing high power transmitters alongside high sensitivity receivers in close proximity to one another. In another example, the present disclosure relates to high power transmitter and high sensitivity receiver systems requiring isolation between the transmission and receiving systems to reduce or eliminate Simultaneous Transmit and Receive (STaR) self-interference (SI) utilizing signal polarization mismatches.

### BACKGROUND

Systems employing transmitter and receiver antennas and/or subsystems in close proximity to one another typically require some level of accounting for Simultaneous Transmit and Receive (STaR) self-interference. STaR self-interference (SI) is particularly prevalent in dual use systems having high powered transmitters and alongside high sensitivity receivers. These systems are common in many applications including, but not limited to, radar applications, communication systems, and the like.

Dual use systems including high power transmitters and high sensitivity receivers tend to suffer from one of two opposing problems. First, to enable high sensitivities on the receiver, the transmitter is limited in power thus reducing the range and effectiveness of the transmission signal. Alternatively, the opposite problem includes increasing the transmission power to maintain or increase the operational range, but at the expense of reducing the sensitivity on the receiver subsystem.

Current solutions for self-interference cancellation (SIC) are therefore limited, particularly where the transmitter and receiver antenna elements are at a set (i.e. immovable) relative distance and have a set beam shape. Currently, these SIC options include cross-polarization of the signals or insertion of physical barriers between the antenna elements such as absorbers, reflective barriers, high impedance metasurfaces, or the like.

STaR solutions involving cross-polarization isolation tend to include a near-field polarization mismatched antennas, which reduces transmission coupling to the receiver but is detrimental to the far-field target link where co-polarization is often required on both transmit and receive. Alternatively, physical barrier solutions, including absorbers, reflective barriers, high impedance metasurfaces, or the like, are placed between the transmission and receiver antenna subsystems. These barriers typically improve isolation to some extent, but their effect is often limited by volume restrictions. Thus, for systems dealing with STaR self-interference, current solutions often require sacrificing transmission power for better receiver sensitivity or alternatively sacrificing receiver sensitivity for increased transmission power.

### SUMMARY

The present disclosure addresses these and other issues by providing a Simultaneous Transmit and Receive (STaR) system utilizing high power transmitters and high sensitivity receivers in conjunction with one or more signal polarizers to maintain far-field polarization efficiency for both transmission and reception of same (or similar) frequency content at the same time. This STaR system maintains far-field polarization efficiency to remote target(s) while simultaneously introducing a near-field polarization mismatch between the transmission and receiver subsystems for higher isolation and reduced coupling.

In one aspect, an exemplary embodiment of the present disclosure may provide a simultaneous transmit and receive (STaR) system comprising: a transmitter subsystem having at least one transmit antenna operable to generate a first signal to a remote target, wherein the transmitter subsystem, the first signal, and a second signal from the remote target are co-polarized; a receiver subsystem having at least one receiver antenna operable to receive the second signal from the remote target, wherein the second signal is co-polarized with the first signal and the receiver subsystem is orthogonally polarized relative to the polarization of the second signal; and at least one polarizer between the remote target and the receiver subsystem operable to convert the polarization of the second signal to have a polarization that is orthogonal to the first signal and substantially the same as the polarization of the receiver subsystem. This exemplary embodiment or another exemplary embodiment may further provide wherein the transmitter subsystem and the receiver subsystem are simultaneously active. This exemplary embodiment or another exemplary embodiment may further provide wherein the transmitter subsystem and the receiver subsystem operate at the substantially the same frequency. This exemplary embodiment or another exemplary embodiment may further provide a near field polarization mismatch between the transmitter subsystem and the receiver subsystem. This exemplary embodiment or another exemplary embodiment may further provide wherein the near-field polarization mismatch reduces self-interference between the transmitter and receiver subsystems by reducing transmit to receiver coupling. This exemplary embodiment or another exemplary embodiment may further provide a first platform operable to carry the transmitter subsystem, the receiver subsystem, and the polarizer; wherein the transmitter subsystem and receiver subsystem interact with remote target(s) simultaneously. This exemplary embodiment or another exemplary embodiment may further provide wherein the second signal from the remote target is a reflected signal. This exemplary embodiment or another exemplary embodiment may further provide wherein the remote target further comprises: a receiver operable to receive the first signal and a transmitter operable to transmit the second signal.

In another aspect, an exemplary embodiment of the present disclosure may provide a simultaneous transmit and receive (STaR) system comprising: a transmitter subsystem having at least one transmit antenna operable to generate a first signal to a remote target; a receiver subsystem having at least one receiver antenna operable to receive a second signal from the remote target, wherein the transmitter subsystem, the first signal, the receiver subsystem, the second signal, and the remote target are co-polarized; and at least one polarizer between the transmitter subsystem and receiver subsystem operable to convert the polarization of substantially all portions of the first signal that are directed from the transmitter subsystem to the receiver subsystem to have a polarization that is orthogonal to the polarization of the receiver subsystem. This exemplary embodiment or another exemplary embodiment may further provide wherein the transmitter subsystem and the receiver subsystem are simultaneously active. This exemplary embodiment or another exemplary embodiment may further provide wherein the transmitter subsystem and the receiver subsystem operate at substantially the same frequency. This exemplary embodiment or another exemplary embodiment may further provide a near field polarization mismatch between the receiver subsystem and substantially all portions of the first signal that are directed from the transmitter subsystem to the receiver subsystem. This exemplary embodiment or another exemplary embodiment may further provide wherein the near-field polarization mismatch reduces self-interference between the transmitter and receiver subsystems by reducing transmit to receiver coupling. This exemplary embodiment or another exemplary embodiment may further provide a first platform operable to carry the transmitter subsystem, the receiver subsystem, and the polarizer; wherein the transmitter subsystem and receiver subsystem interact with remote target simultaneously.

In yet another aspect, an exemplary embodiment of the present disclosure may provide a method of reducing self-interference in simultaneous transmit and receive (STaR) system comprising: generating a first signal having a first polarization from a transmitter subsystem towards a co-polarized remote target; receiving a second signal having the first polarization from the co-polarized remote target with a receiver subsystem; and changing the first polarization of one of all portions of the first signal that are directed from the transmitter subsystem to the receiver subsystem and the entire second signal to have a second polarization that is orthogonal to the first polarization. This exemplary embodiment or another exemplary embodiment may further provide wherein changing the first polarization of all portions of the first signal that are directed from the transmitter subsystem to the receiver subsystem and the entire second signal to have a second polarization is accomplished via at least one polarizer. This exemplary embodiment or another exemplary embodiment may further provide wherein changing the first polarization of all portions of the first signal that are directed from the transmitter subsystem to the receiver subsystem and the entire second signal to have a second polarization further comprises: changing the first polarization of the entire second signal to the second orthogonal polarization when the receiver subsystem is orthogonally polarized relative to the transmitter subsystem. This exemplary embodiment or another exemplary embodiment may further provide wherein the polarizer is between the remote target and the receiver subsystem. This exemplary embodiment or another exemplary embodiment may further provide wherein changing the first polarization of all portions of the first signal that are directed from the transmitter subsystem to the receiver subsystem and the entire second signal to have a second polarization further comprises: changing the first polarization of all portions of the first signal that are directed from the transmitter subsystem to the receiver subsystem to the second orthogonal polarization when the receiver subsystem is co-polarized relative to the transmitter subsystem. This exemplary embodiment or another exemplary embodiment may further provide wherein the polarizer is between the transmitter subsystem and the receiver subsystem.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a block diagram of a first embodiment of a polarizer-assisted Simultaneous Transmit and Receive (STaR) system, according to one aspect of the present disclosure.

FIG. 2 is a flow chart representing a method of use for the first embodiment of the polarizer-assisted STaR system from FIG. 1, according to one aspect of the present disclosure.

FIG. 3 is a block diagram of a second embodiment of a polarizer-assisted simultaneous transmit and receive system, according to one aspect of the present disclosure.

FIG. 4 is a flow chart representing a method of use for the second embodiment of the polarizer-assisted STaR system from FIG. 3, according to one aspect of the present disclosure.

Similar numbers refer to similar parts throughout the drawings.

### DETAILED DESCRIPTION

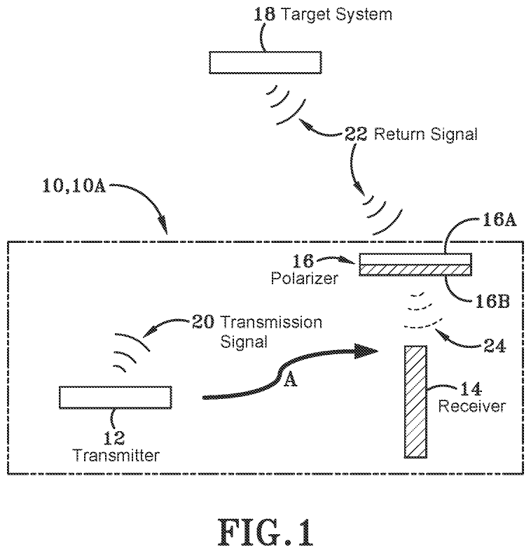

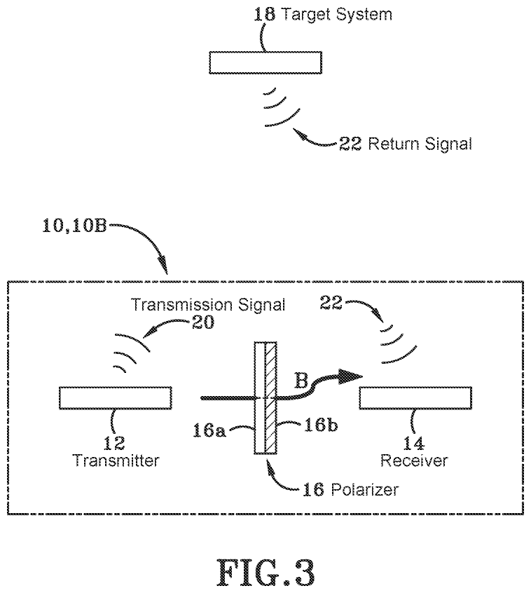

With reference generally to FIGS. 1 and 3, block diagrams of Simultaneous Transmit and Receive (STaR) systems 10 are generally shown and will be generally described. STaR systems, as used herein, are systems incorporating a transmission component and a receiver component that simultaneously operate at the same frequency or at very closely spaced frequencies. Accordingly, FIG. 1 shows a block diagram of a first embodiment of a STaR system 10A according to one aspect of the present disclosure, while FIG. 3 shows a block diagram of a second embodiment of a STaR system 10B according to another aspect of the present disclosure. These embodiments may be substantially similar in that each embodiment may include a transmitter subsystem 12, a receiver subsystem 14, and at least one polarizer 16, and may operate with or in conjunction with a target system 18. The differences between the first and the second embodiments 10A and 10B of STaR system 10 will be described in further detail below, but generally relate to the positioning and orientation of one or more of these particular elements.

Generally speaking, STaR systems are dual use systems operable to send a high powered transmission signal while simultaneously employing high sensitivity receivers in close proximity, and at the same or substantially the same (i.e. very closely spaced operational frequencies, to the transmission subsystem. STaR systems can only be successfully implemented if the system incorporates a sufficient amount of self-interference cancellation (SIC), which generally involves suppressing the transmit signal below acceptable levels for the high sensitivity receiver subsystem. This typically involves suppressing the transmit signal to prevent saturation of the receiver but also to minimize or eliminate spurious signals generated from the nonlinear nature of receiver subsystem components.

With continued reference to FIGS. 1 and 3, the elements and components of STaR systems 10 will be described generally. A detailed discussion of each embodiment will be provided further below. As mentioned above, STaR systems 10 may include a transmitter subsystem 12 which may be or further include one or more transmit antennas, along with any other associated transmission equipment, including, but not limited to, processors, signal generators, encoders, or the like, or suitable combinations thereof.

Similarly, STaR systems 10 may include a receiver subsystem 14 which may be or include one or more receiver antennas along, with any other associated receiver equipment, including, but not limited to, processors, receivers, encoders, or the like, or suitable combinations thereof.

Accordingly, these transmitter and receiver subsystems 12 and 14 will be understood to further include all necessary components such as converters, power supplies, wiring, mounting hardware, and any other suitable and/or necessary components for the normal operation thereof. Accordingly, references to transmitter subsystem 12 will be understood to include such necessary components. Similarly, references to receiver subsystem 14 will likewise be understood include all necessary components, as described above.

The antenna elements utilized in both transmitter and receiver subsystems 12 and 14 may further be or include one or more transmission antennas in any suitable configuration, or may alternatively be one or more antenna arrays in any suitable configuration. These antennas may be or include monopole, dipole, directional, or omni-directional antennas, or any suitable combination thereof. Antennas of transmitter and receiver subsystems 12 and 14 may be arranged in any desired configuration appropriate for the installation conditions and may include existing legacy configurations as already installed and/or in operation on a platform (not shown), as described further herein.

Polarizer 16 may be any suitable signal polarizer operable to change the polarization of a radio frequency (RF) signal as described further below. Polarizer 16 is shown in FIGS. 1 and 3 as generally having two sides, namely, a first side 16A and a second side 16B. These sides 16A and 16B are provided as reference to the matching polarization of the signal entering and/or leaving polarizer 16, as described further below. According to one example, first side 16A may correspond to an incoming or return signal (such as signal 22) while second side 16B may correspond to an outgoing signal (such as signal 24) having a different polarization from return signal, as discussed further herein.

Each element and component of transmitter subsystem 12, receiver subsystem 14, and/or polarizer 16 may be or include legacy system assets, which may be utilized for their standard function or may alternatively be new and/or modified assets, which may be utilized according to the principles discussed further herein.

As mentioned above, STaR systems 10 may be carried by or otherwise integrated into a platform (not shown) which may be a mobile unit operable to utilize RF systems. According to one aspect, platform may be or include man-portable systems, ground vehicles, sea-based vehicles, aircraft, including manned and unmanned, or the like, or suitable combinations thereof (such as in a squad or fleet) and may include both civilian and/or military assets provided they are operable to carry the necessary components of STaR systems 10 and are further capable of carrying out the operations described further herein.

In one embodiment, target system 18, or simply target 18, may be an outside or remote target of interest having both transmit and receive functions utilizing a known polarization. According to one aspect, target 18 can be co-polarized with transmitter subsystem 12 and/or receiver subsystem 14, as described further herein. Target 18 may be a separate and remote STaR system similar to STaR system 10 described herein, or may be any other suitable system operable to transmit and receive RF signals. According to one example, target 18 may be an identical STaR system operating on a remote platform and may be substantially similar to the platform employing STaR systems 10 (such as two similar aircraft) or may be any other suitable system and platform combination as dictated by the desired implementation and operational parameters. One example of using an active receiver and transmitter is an Identification Friend and Foe (IFF) transponder. The transmission signal 20 would be received and processed by the target system 18 and it would then output the return signal 22. Another embodiment is a passive system where the transmission signal 20 is reflected from the target system 18 resulting in the return signal 22.

With reference to FIG. 1, the first embodiment of STaR system 10A will now be described in further detail. This first embodiment of STaR system 10A represents a system wherein the transmitter subsystem 12 and target 18 are co-polarized but the receiver subsystem 14 has an orthogonal polarization relative thereto. As used herein, co-polarized means that the signals and/or the subsystems have the same polarization. This is represented by both the orthogonal orientation of receiver subsystem 14 relative to transmitter subsystem 12, and also indicated by the diagonal lines shown in receiver subsystem 14. In the example provided, signal 24 from the polarizer 16 to the receiver 14 is the signal of interest, and has a different polarization than the return signal 22 from the remote target 18, as discussed further below. In this exemplary scenario, the orthogonal polarization mismatch between transmitter subsystem 12 and receiver subsystem 14 provides inherent isolation since the different polarizations do not couple into one another. Further according to this example, transmitter subsystem 12 may be vertically linearly polarized (v-pol or v-polarized) while receiver subsystem 14 may be horizontally linearly polarized (h-pol or h-polarized), leading to no transmitter to receiver coupling.

Although described herein with reference to linear polarization, it will be understood that STaR system 10 may utilize any orthogonally paired polarizations, including all known variations in electromagnetics such as linear, circular, or elliptical. Thus, references herein to the polarization of transmitter and/or receiver elements, subsystems, signals, or the like are understood to equally apply to all known polarization variations, of which linear polarization is described as an exemplary operational use of STaR system 10.

Accordingly, when transmitter subsystem 12 generates a transmission signal 20, any signal leaking or otherwise passing from transmitter subsystem 12 directly to receiver subsystem 14 will not couple and self-interference in the near-field will not occur. The portion of the transmission signal leaking from the transmitter subsystem 12 to the receiver subsystem 14 is indicated by arrow A in FIG. 1. This may allow the transmission signal 20 to remain high powered without overwhelming the receiver subsystem 14 providing in a higher allowable output power for the transmitter subsystem 12.

In one example the transmitter subsystem 12 is co-polarized with target 18, target 18 may send, or otherwise cause an incoming or return signal 22 to be directed back to STaR system 10. The return signal 22 may be any signal returning to the receiver subsystem 14 from target 18 and may include signals that are transmitted from target 18 to STaR system 10. In a further example, the return signals 22 that are reflected off of target 18, or any other suitable type of return signal is co-polarized with the transmitter subsystem 12. Because of the orthogonal polarization mismatch between the transmitter subsystem 12 and receiver subsystem 14 that prevents coupling between the subsystems 12 and 14, a similar mismatch would exist between return signal 22 and receiver subsystem 14, thus reducing the sensitivity of the receiver subsystem 14, thwarting its ability to detect the return signal 22.

As shown in the first embodiment of STaR system 10A in FIG. 1, polarizer 16 may therefore be inserted into the path of the return signal 22 between target 18 and receiver subsystem 14. Polarizer 16 may allow for the incoming return signal 22 to enter the polarizer having the same vertical polarization as the transmit signal 20. The signal may exit from the second side 16B of the polarizer 16 having been changed to an h-pol signal to match the receiver subsystem 14. This h-polarized signal is shown as signal 24 between polarizer 16 and receiver subsystem 14. The insertion of polarizer 16 into the path of the return signal 22 may allow for higher sensitivity of the receiver subsystem 14 without sacrificing the allowable output power of transmitter subsystem 12. Similarly, the orthogonal polarization mismatch between transmitter subsystem 12 (v-pol) and receiver subsystem 14 (h-pol) prevents coupling in the near-field while maintaining a natural co-polarization between the transmitter subsystem 12 and the target 18.

With reference to FIG. 3, the second embodiment of STaR system 10B will now be discussed in more detail. The second embodiment of STaR system 10B may be substantially similar to the first embodiment of STaR system 10A in that it may include a transmitter subsystem 12, a receiver subsystem 14, and a polarizer 16; however, the second embodiment 10B may differ in that both the transmitter subsystem 12 and receiver subsystem 14 may be co-polarized to each other and to the outside target 18, as well at the specific placement of the polarizer 16 within STaR system 10B. This is illustrated in FIG. 3 by the orientation of transmitter subsystem 12, receiver subsystem 14, and target 18 being parallel. Under normal operation, this configuration having the transmitter subsystem 12 and receiver subsystem 14 co-polarized to the target 18 provides a low polarization mismatch for the transmitter to receiver and to the end target link, i.e. high sensitivity to the return signal 22 by the receiver subsystem 14.

Operating a normal STaR system in this configuration would tend to lead to high transmitter to receiver coupling which may cause the transmission signal 20 to overwhelm the receiver subsystem 14. Accordingly, as with STaR system 10A, STaR system 10B employs a polarizer 16; however, in this embodiment, polarizer 16 may be placed between the transmitter subsystem 12 and the receiver subsystem 14 such that any portion of the transmission signal 20 leaking or otherwise moving from the transmitter subsystem 12 directly towards and into the receiver subsystem 14 in the near-field passes through the polarizer 16. This may induce a polarization shift in the leaked signal creating a polarization mismatch between the transmitter subsystem 12 and the receiver subsystem 14, again leading to low coupling therebetween. The portion of the transmission signal leaking from the transmitter subsystem 12 to the receiver subsystem 14 through the polarizer 16 is indicated by arrow B in FIG. 3. As mentioned previously herein and discussed in more detail below, by providing a system such as STaR system 10 having an effective polarization mismatch for the transmitter 12 to receiver 14 link but a co-polarization between the transmitter subsystem 12 and the target 18 allows for a higher sensitivity on the receiver subsystem 14 while maintaining a high allowable output power from transmitter subsystem 12. In particular, the incorporation of polarizer 16 in either the return signal 22 pathway, or alternatively between the transmitter subsystem 12 and receiver subsystem 14, ultimately provides a net benefit of reduced coupling between the transmitter 12 and receiver 14 subsystems and a net gain in allowable output power from the transmitter subsystem 12.

Having thus described the elements and components of STaR system 10, including first embodiment 10A and second embodiment 10B thereof, the operation and methods of use will be described in more detail.

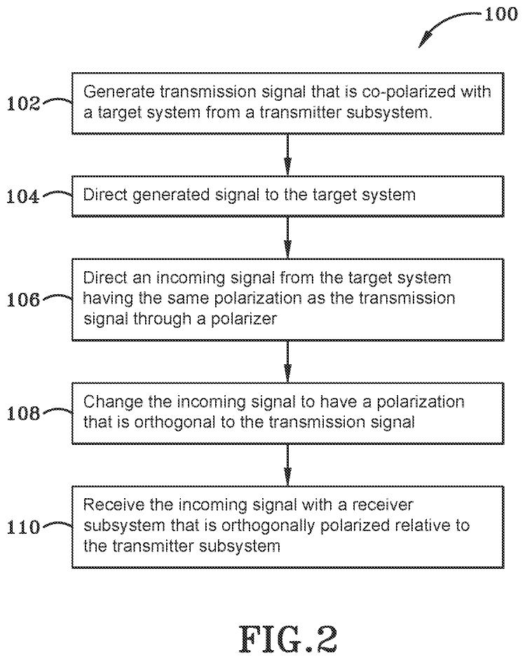

In particular, the operation of first embodiment 10A of STaR system 10 will first be described in more detail with the operation of second embodiment 10B of STaR system 10 discussed below. With reference to FIG. 2, the operation of STaR system 10A is illustrated in a flow chart as process 100. Accordingly, STaR system 10A may operate similar to other simultaneous transmit and receive systems but with the insertion of polarizer 16 into the return signal 22 pathway, as mentioned above. Specifically, STaR system 10A may generate a transmission signal 20 from the transmitter subsystem 12 and direct the signal 20 towards the target system 18. This generated transmission signal 20, in one example, is co-polarized with the target system 18 in that the polarization of transmission signal 20 may match the polarization of a receiver within target system 18. This allows maximum output power for transmission subsystem 12 to generate the signal 20 to the target system 18. The generation of the co-polarized signal to the target system is shown as step 102 in process 100 while the direction of the generated signal towards the target system is shown at step 104 therein. In a further example, the generated transmission signal 20 from the transmitter 12 is co-polarized with the target system 18, as shown in step 102, and the signal is reflected from the remote target 18 resulting in the return signal 22 that has the same polarity as shown in step 104.

As the target system 18 is thus contemplated to be co-polarized with the transmitter subsystem 12 of STaR system 10A, the incoming return signal 22 from the target system 18 is expected to have the same polarization as the transmission signal 20 generated from the transmitter subsystem 12 to the target system 18. In this embodiment of STaR system 10A; however, the receiver subsystem 14 and antennas therein are contemplated to be orthogonally polarized to the transmitter subsystem 12 and therefore orthogonally to the return signal 22. Therefore, the return signal 22 would not couple with the receiver subsystem 14, which would have further difficulty detecting and/or receiving the return signal 22 from target system 18 due to this polarization mismatch. Accordingly, the next step in process 100 is to direct the return signal 22 through the polarizer 16, which is shown as step 106 in process 100. Similarly, due to the orthogonal polarization of the transmitter and receiver subsystems 12 and 14, any portion of the transmission signal 20 moving or otherwise leaking from the transmitter subsystem 12 towards and into the receiver subsystem 14 is orthogonally polarized relative to the receiver subsystem 14 and will not result in transmitter to receiver coupling.

As mentioned above, the polarizer 16 may operate to convert or otherwise change the polarization of the return signal 22 by ninety degrees to have an orthogonal polarization relative to the transmission signal 20. The newly converted signal 24 (referred to herein as polarized signal 24) may then be directed to the receiver subsystem 14. This conversion of the return signal 22 to change the polarization thereof is shown at step 108 in process 100. Receiving and processing the return signal with receiver subsystem 14 is indicated as step 110 in process 100.

Finally, as the return signal 22 has been changed into polarized signal 24, the polarized signal 24 now matches and is co-polarized with the receiver subsystem 14 and is orthogonal to the transmitter subsystem 12 and therefore may be detected and processed normally. This arrangement, as mentioned above, provides the benefit of increased output power for transmitter subsystem 12 while maintaining a high sensitivity of receiver subsystem 14 without excess coupling between subsystems 12 and 14 thus providing a net positive benefit to both transmitter subsystem 12 and receiver subsystem 14 when operated according to process 100.

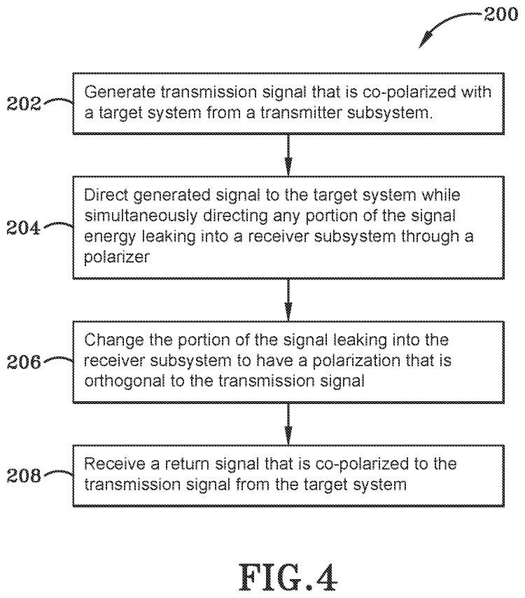

With reference to FIG. 4, the operation of second embodiment 10B of STaR system 10 is shown in a representative flow chart as process 200. Process 200 may be similar to process 100 for the operation of the first embodiment 10A in that the first step in process 200 is to generate a transmission signal 20 from the transmitter subsystem 12. Signal 20 is again co-polarized with target system 18.

Where the operation of second embodiment 10B of STaR system 10 differs is that any signal or any portion of the signal 20 that leaks between transmitter subsystem 12 and receiver subsystem 14 may be the signal that is directed through the polarizer 16 which is now situated between the two subsystems 12 and 14 (as shown in FIG. 3). Directing the portion or portions of the transmitter signal 20 passing between transmitter subsystem 12 and receiver subsystem 14 through the polarizer 16 is indicated at step 204 in process 200.

The polarizer 16 itself may operate in the same manner as the polarizer 16 in first embodiment 10A of STaR system 10 in that the polarizer 16 may change or convert the polarization of the transmission signal 20 by ninety degrees to have an orthogonal polarization relative to the transmitter subsystem 12 and receiver subsystem 14. This now orthogonal polarization will prevent coupling between the transmitter and receiver subsystems 12 and 14 while allowing both subsystems 12 and 14 to remain co-polarized with target system 18. The changing of the polarization of the signal or portion of signal 20 leaking into the receiver subsystem 14 is indicated as step 206 in process 200.

Finally, as both transmitter and receiver subsystems 12 and 14 are co-polarized with target system 18, the return signal 22 from target 18 may be received and processed by the receiver subsystem 14 normally, without the need to reduce or subdue the output power of the transmitter subsystem 12 as the presence of polarizer 16 between the transmitter subsystem 12 and receiver subsystem 14 prevents transmitter to receiver coupling while simultaneously allowing receiver subsystem 14 to maintain a high sensitivity to the co-polarized return signal 22 from target system 18. The receiving and processing of the return signal 22 is indicated as step 208 in process 200.

It will be understood that the exact benefits to output power and receiver sensitivity described and realized through the systems described herein may vary depending on the specific implementation parameters. By way of one non-limiting example, STaR system 10 may realize one level of net benefit when installed on an aircraft while realizing a differing level of net benefit when installed on a ground-based vehicle. Accordingly, the specific implementation parameters, including the type of platform employed, the distance between the transmitter subsystem 12 and receiver subsystem 14, the types of antennas utilized by the subsystems 12 and 14, the specific type of polarizer utilized, the frequency bandwidth related thereto, and/or other outside environmental factors will affect the total benefit realized; however, it will be understood that the utilization of polarizer 16 either in the return signal path (as shown with first embodiment 10A) and an orthogonally polarized receiver subsystem 14 or alternatively with polarizer 16 between co-polarized transmitter and receiver subsystems 12 and 14, will provide an overall net benefit to both transmitter subsystem 12 and receiver subsystem 14 in that coupling between the subsystems 12 and 14 may be reduced while simultaneously allowing for a greater output power for transmitter subsystem 12.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic” , as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A simultaneous transmit and receive (STaR) system comprising:
a transmitter subsystem having at least one transmit antenna operable to generate a first signal to a remote target, wherein the transmitter subsystem, the first signal, and a second signal from the remote target are co-polarized;
a receiver subsystem having at least one receiver antenna operable to receive the second signal from the remote target, wherein the receiver subsystem is orthogonally polarized relative to the polarization of the second signal; and
at least one polarizer between the remote target and the receiver subsystem operable to convert the polarization of the second signal to have a polarization that is substantially orthogonal to the first signal and substantially the same as the polarization of the receiver subsystem.

2. The STaR system of claim 1 wherein the transmitter subsystem and the receiver subsystem are simultaneously active.

3. The STaR system of claim 2 wherein the transmitter subsystem and the receiver subsystem operate at the substantially the same frequency.

4. The STaR system of claim 1 further comprising:
a near field polarization mismatch between the transmitter subsystem and the receiver subsystem.

5. The STaR system of claim 4 wherein the near-field polarization mismatch reduces self-interference between the transmitter and receiver subsystems by reducing transmit to receiver coupling.

6. The STaR system of claim 1 further comprising:
a first platform operable to carry the transmitter subsystem, the receiver subsystem, and the polarizer;
wherein the transmitter subsystem and receiver subsystem interact with the remote target simultaneously.

7. The STaR system of claim 1 wherein the second signal from the remote target is a reflected signal.

8. The STaR system of claim 1 wherein the remote target further comprises:
a receiver operable to receive the first signal and a transmitter operable to transmit the second signal.

9. A simultaneous transmit and receive (STaR) system comprising:
a transmitter subsystem having at least one transmit antenna operable to generate a first signal to a remote target;
a receiver subsystem having at least one receiver antenna operable to receive a second signal from the remote target, wherein the transmitter subsystem, the first signal, the receiver subsystem, the second signal, and the remote target are co-polarized; and
at least one polarizer between the transmitter subsystem and receiver subsystem operable to convert the polarization of substantially all portions of the first signal that are directed from the transmitter subsystem to the receiver subsystem to have a polarization that is orthogonal to the polarization of the receiver subsystem.

10. The STaR system of claim 9 wherein the transmitter subsystem and the receiver subsystem are simultaneously active.

11. The STaR system of claim 10 wherein the transmitter subsystem and the receiver subsystem operate at substantially the same frequency.

12. The STaR system of claim 11 further comprising:
a near field polarization mismatch between the receiver subsystem and all portions of the first signal that are directed from the transmitter subsystem to the receiver subsystem.

13. The STaR system of claim 12 wherein the near-field polarization mismatch reduces self-interference between the transmitter and receiver subsystems by reducing transmit to receiver coupling.

14. The STaR system of claim 9 further comprising:
a first platform operable to carry the transmitter subsystem, the receiver subsystem, and the polarizer;
wherein the transmitter subsystem and receiver subsystem interact with remote target(s) simultaneously.

15. A method of reducing self-interference in simultaneous transmit and receive (STaR) system comprising:
generating a first signal having a first polarization from a transmitter subsystem towards a co-polarized remote target;
receiving a second signal having the first polarization from the co-polarized remote target with a receiver subsystem; and
changing the first polarization of one of all portions of the first signal that are directed from the transmitter subsystem to the receiver subsystem and the entire second signal to have a second polarization that is orthogonal to the first polarization.

16. The method of claim 15 wherein changing the first polarization of all portions of the first signal that are directed from the transmitter subsystem to the receiver subsystem and the entire second signal to have a second polarization is accomplished via at least one polarizer.

17. The method of claim 16 wherein changing the first polarization of all portions of the first signal that are directed from the transmitter subsystem to the receiver subsystem and the entire second signal to have a second polarization further comprises:
changing the first polarization of the entire second signal to the second orthogonal polarization when the receiver subsystem is orthogonally polarized relative to the transmitter subsystem.

18. The method of claim 17 wherein the polarizer is between the remote target and the receiver subsystem.

19. The method of claim 16 wherein changing the first polarization of all portions of the first signal that are directed from the transmitter subsystem to the receiver subsystem and the entire second signal to have a second polarization further comprises:
changing the first polarization of all portions of the first signal that are directed from the transmitter subsystem to the receiver subsystem to the second orthogonal polarization when the receiver subsystem is co-polarized relative to the transmitter subsystem.

20. The method of claim 19 wherein the polarizer is between the transmitter subsystem and the receiver subsystem.
